(19) United States
(12) Patent Application Publication
(10) Pub. No.: US 2015/0266992 A1
(43) Pub. Date: Sep. 24, 2015

(54) NCO PREPOLYMERS OF LOW MONOMER CONTENT AND THEIR USE

(71) Applicants: Emmanouil SPYROU, Schermbeck (DE); Holger LOESCH, Herne (DE); Andrea DIESVELD, Gescher (DE); Andrea THESING, (US)

(72) Inventors: Emmanouil Spyrou, Schermbeck (DE); Holger Loesch, Herne (DE); Andrea Diesveld, Gescher (DE); Andrea Thesing, Ahaus (DE)

(73) Assignee: EVONIK DEGUSSA GMBH, Essen (DE)

(21) Appl. No.: 14/431,863

(22) PCT Filed: Sep. 9, 2013
(86) PCT No.: PCT/EP13/68541

§ 371 Date: Mar. 27, 2015

(30) Foreign Application Priority Data
Sep. 27, 2012 (DE) 10 2012 217 549.0

(51) Int. Cl. C08G 18/10; C08G 18/78; C08G 18/48

(52) U.S. Cl. CPC C08G 18/10; C08G 18/48; C08G 18/7843

(57) ABSTRACT

The invention relates to a low-monomer NCO prepolymer composition of the type A-B-A, which is obtained by reacting CH-acidic compounds with diisocyanates, and methods for the production and use thereof.

The invention discloses a low-monomer-content A-B-A-type NCO-prepolymer composition which is obtained by reaction of C—H-acidic compounds with diisocyanates, and also processes for preparation thereof and use.

Polyisocyanates are used preferentially in paint, adhesive and sealant technology on account of their high reactivity and their diverse usefulness. For reasons of toxicology and of workplace health, free monomeric diisocyanates are undesirable. Efforts are therefore made to convert diisocyanates into NCO-containing prepolymers through a reaction with alcohol-containing components. This is accomplished, for example, by reaction with polyester or polyether alcohols, followed by distillative removal of the excess monomeric diisocyanate.

In general, however, the resultant low-monomer-content NCO-containing prepolymer has a much lower NCO content and a significantly increased viscosity. Both qualities are undesirable. Even now, therefore, a search is still on for low-monomer-content NCO-containing prepolymers having a high NCO content and a low viscosity. For the aforementioned reasons, there is still a need for low-monomer-content NCO-containing prepolymers whose monomer content is low, in conjunction with an NCO content in the prepolymers and with a low viscosity.

An object of the invention, therefore, was the development of prepolymers which do not have the aforementioned disadvantages and which combine a low monomer content with a high NCO group content in the prepolymers and a very low viscosity.

Surprisingly it has now been found that reaction products of an excess of diisocyanates and CH-acidic compounds, following removal of the excess monomeric diisocyanate, produce precisely such desired low-monomer-content NCO-containing prepolymers with a high NCO content and a low viscosity.

The objects have been achieved by means of the subject matter of claim 1 and also by a process according to claim 6, with advantageous embodiments being elucidated in the dependent claims and in detailed form in the description.

The invention provides reaction products of

(i) an excess of at least one aromatic, aliphatic, (cyclo)aliphatic and/or cycloaliphatic diisocyanate with

(ii) at least one CH-acidic compound which comprises at least two CH-acidic hydrogen atoms, with removal of the excess diisocyanate after the reaction.

Likewise provided by the invention is a composition comprising low-monomer-content NCO prepolymers, comprising at least one prepolymer of the general formula I,

OCN—R—NH—(C=O)—B—(C=O)—NH—R—NCO (I)

which is obtained by in a first step reacting:

(i) monomeric diisocyanate compounds OCN—R—NCO of the formula II with a

(ii) organofunctional C—H-acidic compound HBH of the formula III having at least two acidic hydrogen atoms,

where R in formula I and formula II in each case independently is a bifunctional organofunctional radical which comprises aromatic, aliphatic and (cyclo)aliphatic and/or cycloaliphatic bifunctional radicals,

an organofunctional C—H-acidic compound HBH of the formula III having at least two acidic hydrogen atoms comprises substituted linear aliphatic, (cyclo)aliphatic or branched aliphatic compounds having 3 to 25 C atoms, which has at least one electron-withdrawing group or at least one electron-withdrawing substituent on a carbon atom located alpha to the C—H-acidic carbon atom; more particularly, the electron-withdrawing group or the substituent comprises at least one atom which is more electronegative than a C atom, and correspondingly the electron-withdrawing substituent is more electronegative than a carbon atom, and the electron-withdrawing group preferably comprises or is selected from ester, sulfoxide, sulfone, nitro, phosphonate, nitrile, isonitrile or carbonyl groups, preferably nitrile groups or ester groups, and

in a second step, removing unreacted monomeric diisocyanate compounds of the formula II.

According to one preferred embodiment, the (ii) organofunctional C—H-acidic compound HBH of the formula III having at least two acidic hydrogen atoms comprises at least one electron-withdrawing group on a carbon atom located alpha to the C—H-acidic carbon atom, and preferably has two electron-withdrawing groups on both alpha-located carbon atoms, the groups being selected from ester, sulfoxide, sulfone, nitro, phosphonate, nitrile, isonitrile and carbonyl groups. Particularly preferred organofunctional C—H-acidic compounds of the formula III, HBH, include β-dicarbonyl compounds and also derivatives of β-dicarbonyl compounds.

The reaction takes place optionally in the presence of a catalyst, and the catalyst may remain in the composition, and so the composition may contain small amounts of the catalyst.

The formula I can also be represented in simplified form as A-B-A, where the reacted diisocyanates are represented in simplified form as A, with the acidic hydrogen from HBH being present in the urethane groups.

Diisocyanates of the general formula II that are used (component A) are preferably aromatic, aliphatic and (cyclo)aliphatic and/or cycloaliphatic diisocyanates. Diisocyanates of these kinds are described for example in Houben-Weyl, Methoden der organischen Chemie, Volume 14/2, page 61 ff. and in J. Liebigs Annalen der Chemie, Volume 562, pages 75 to 136. Diisocyanates employed with preference include isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), diisocyanatomethylcyclohexane (HXDI), toluidine diisocyanate (TDI), and/or methylenediphenyl diisocyanate (MDI) and also tetramethylxylylene diisocyanate (TMXDI). Especially preferred are IPDI, HDI and H12MDI.

Aliphatic diisocyanates likewise suitable advantageously possess 3 to 16 carbon atoms, preferably 4 to 12 carbon atoms, in the linear or branched alkylene radical, and suitable cycloaliphatic or (cyclo)aliphatic diisocyanates have advantageously 4 to 18 carbon atoms in the cycloalkylene radical, preferably 6 to 15 carbon atoms. By (cyclo)aliphatic diisocyanates the skilled person adequately understands NCO groups bonded aliphatically and cyclically at the same time. Conversely, cycloaliphatic diisocyanates are understood to be those which have only NCO groups bonded directly on the cycloaliphatic ring. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, decane diisocyanate, undecane diisocyanate, and/or dodecane diisocyanate.

Likewise suitable are methyldiphenyl diisocyanates (MDI), such as diphenylmethane 2,2′-diisocyanate, diphenylmethane 2,4-diisocyanate, diphenylmethane 4,4′-diisocyanate or mixtures comprising the aforementioned MDIs, 2,4- and/or 2,6-tolyl diisocyanate (TDI), 4-methylcyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenebis(cyclohexyl) diisocyanate and 1,4-diisocyanato-4-methylpentane.

By (cyclo)aliphatic diisocyanates the skilled person adequately understands NCO groups bonded aliphatically and cyclically at the same time, as is the case with isophorone diisocyanate, for example. Conversely, cycloaliphatic diisocyanates are understood to be those which have NCO groups bonded only directly on the cycloaliphatic ring, an example being H12MDI.

C—H-acidic organofunctional compounds which can be used in accordance with the invention have at least one electronegative group or electronegative substituent on the carbon located alpha to the aliphatic C—H-acidic hydrogen. CH-acidic compounds of the general formula III, HBH (component B), are considered in accordance with the invention to be those compounds which carry a hydrogen atom bonded to an aliphatic carbon atom, the corresponding carbon- hydrogen bond being activated by at least one or more electron-withdrawing groups. The electron-withdrawing group may comprise groups of any atoms which, through inductive effects (e.g. —I effect) and/or mesomeric effects (e.g. —M effect), lead to CH-acidity on the part of the [alpha]-located hydrogen. Examples of electronegative substituents contemplated include halogen atoms. Preferred electronegative groups include ester groups, sulfoxide groups, sulfone groups, nitro groups, phosphonate groups, nitrile groups, isonitrile groups or carbonyl groups. Preferred electron-withdrawing substituents are nitrile groups and ester groups, more preferably the carboxylic methyl ester groups and carboxylic ethyl ester groups. According to one preferred embodiment, the aforementioned compounds may take the form of (β-di-functionalized compounds, such as, preferably, β-dicarbonyl, β-diester, β-dinitrile, β-dinitro, β-disulfoxide, β-disulfone, β-dinitro, β-diphosphonato or β-diisonitrile compounds or of β-di-functionalized compound comprising at least two of the aforementioned electronegative groups or electron-withdrawing substituents.

Preferred organofunctional C—H-acidic compounds HBH of the formula III having at least two acidic hydrogen atoms include diketones, keto esters, diesters, nitriles, and also aliphatic compounds substituted by halogens, linear aliphatic, (cyclo)aliphatic or branched aliphatic compounds having 3 to 25 C atoms, selected from β-dicarbonyl compounds, diketones, keto esters, diesters, nitrile esters, dinitriles and also cyclic diketones and derivatives of the aforementioned compounds. In the formula III the two Hs in HBH represent the acidic hydrogens of the C—H-acidic compound.

Particularly preferred organofunctional C—H-acidic compounds HBH of the formula III having at least two acidic hydrogen atoms are selected from 1,3-cyclohexanedione, dimedone, malonic diesters, acetoacetic esters, more particularly, the ethyl or methyl esters of acetoacetic acid, acetylacetone and/or a mixture comprising at least two of the stated C—H-acidic compounds.

The compositions of the invention contain preferably 0.1 wt % or more of inventive NCO prepolymers having two NCO groups in the general formula (I) in relation to the overall composition, more preferably 1 wt % or more and very preferably 5 wt % or more of NCO prepolymers having two NCO groups. The compositions may likewise contain greater than or equal to 10 wt %, 20 wt % or 50 wt % of NCO prepolymers having two NCO groups in relation to the overall composition. Preferably at the same time a monomer content of less than or equal to 2.0 wt %, particularly less than or equal to 1.0 wt % and very preferably less than or equal to 0.5 wt % of monomers in the overall composition is obtained.

According to a further embodiment of the invention, a process for preparing low-monomer-content NCO prepolymers, and also compositions comprising low-monomer-content NCO prepolymers obtainable by this process, are disclosed, the process comprising

(i) reacting a molar excess of at least one aromatic, aliphatic, (cyclo)aliphatic and/or cycloaliphatic diisocyanate of the formula II and

(ii) at least one organofunctional CH-acidic compound having at least two CH-acidic hydrogen atoms of the formula III,

(iii) and after the reaction removing excess diisocyanate of the formula III, to set a monomer content preferably of less than or equal to 2.0 wt %, more preferably of less than or equal to 0.7 wt %, in relation to the overall composition. It is particularly preferred here if the prepolymer compositions obtained by the process of the invention contain greater than or equal to 10 wt %, preferably greater than or equal to 20 wt %, of prepolymers having two NCO groups of the general formula (I) in the overall composition.

The reaction of the (i) diisocyanate and the (ii) CH-acidic compound takes place preferably in a molar ratio of 1.1:1 to 100:1, more particularly of 10:1 to 1:1, very preferably of 5:1 to 2:1, including the limit values. The reaction may take place at 20 to 200° C. until the theoretical NCO number corresponding to the molar conversion of two acidic hydrogen atoms of the C—H-acidic compound used with the diisocyanates used is reached. The theoretical NCO number is given by the molar amount of diisocyanate used which in the ideal case reacts in a molar ratio of 2:1 with the C—H-acidic compounds. The theoretical NCO number is based on the overall composition in wt %.

After the reaction, the cooled composition may optionally be treated further, by removal of solvent optionally present and also of the excess of monomeric diisocyanates, in particular until the monomer content is less than 2.0 wt %. This is done preferably by a gentle distillation, as for example short-path distillation or thin-film distillation, preferably at temperatures of 120-220° C. and pressures of 0.001 mbar to 100 mbar, more particularly of 0.001 mbar to 50 mbar. Preference is given to a short-path distillation or thin-film distillation at temperatures of 100 to 180° C. and pressures of 0.001 mbar to 50 mbar, preferably at pressures of 0.01 mbar to 20 mbar. The resulting compositions comprising the NCO prepolymers have a monomer content of <2 wt %, preferably <1 wt % and more preferably <0.5 wt %. The reaction mixture is preferably cooled and subjected to a short-path distillation, more particularly with a liquid-phase temperature of 100 to 160° C., preferably around 150° C. plus/minus 10° C. and a pressure of 0.1 to 1 mbar, preferably around 0.5 mbar with a fluctuation of plus/minus 0.25 mbar.

The reaction of diisocyanate and of the CH-acidic compound may generally take place in the presence of an inert solvent or without inert solvent. The reaction takes place preferably without addition of a solvent. For this, in the process, the diisocyanate and the C—H-acidic compound are mixed in a molar ratio of A to B of 1.1 to 100, preferably 2 to 5, in suitable assemblies and maintained at a reaction temperature of 20 to 220° C., preferably 40 to 100° C., until the theoretical NCO number (corresponding to the complete reaction of both CH-acidic hydrogen atoms of HBH of the formula III (component B)) is reached. The principal product is an A-B-A adduct.

To accelerate the reaction it is possible to use catalysts known to the skilled person, such as organometallic salts, for example. Examples thereof are dibutyltin dilaurate or zinc octoate, or else metal-free bases such as triethylamine or diazabicyclooctane, for example.

Disclosed according to a further subject of the invention is the use of a low-monomer-content composition of NCO prepolymers of the general formula (I) for preparing reactive OH—and/or NCO-urethane prepolymers, by reacting the low-monomer-content NCO prepolymers with polyols, the molar ratio of NCO groups to OH groups being from 1:10 to 10:1.

Polyols comprise polyhydric alcohols, monomeric, oligomeric or polymeric polyols. Polyhydric alcohols comprise the monomeric polyols such as the monomeric diols, triols and monomeric compounds having greater than or equal to two HO groups (hydroxyl groups). For chain termination the additional use of monoalcohols is possible.

Monomeric diols which can be used include for example the following, without the polyols being restricted to these: ethylene glycol, triethylene glycol, butane-1,4-diol, pentane-1,5-diol, hexane-1, 6-diol, 3-methylpentane-1,5-diol, Neopentyl glycol, 2,2,4-(2,4,4-)trimethylhexane diol, and also hydroxypivalic acid neopentyl glycol ester.

Other monomeric triols and polyols which can be used include for example the following, without the polyols being restricted to these: trimethylolpropane, ditrimethylolpropane, trimethylolethane, hexane-1,2,6-triol, butane-1,2,4-triol, tris(β-hydroxyethyl) isocyanurate, pentaerythritol, mannitol or sorbitol.

Preferred polymeric polyols may be selected from the following, and other polyols familiar to the skilled person may likewise be used, such as, for example, polyesters, polycaprolactones, polyethers, polycarbonates or poly(meth)acrylates having terminal OH groups.

In accordance with the inventive use, the low-monomer-content NCO prepolymers of the general formula (I) may be used for preparing reactive OH—or NCO-urethane prepolymers through reaction with polyols in an NCO/OH ratio of preferably 1:2 to 2:1. With an NCO excess an NCO-containing urethane prepolymer is obtained which is able to crosslink, for example, through moisture curing. By means of an OH excess it is possible for these compounds to crosslink through the reaction of the blocked NCO groups with the free OH groups, with elimination of alcohol.

The reaction of the NCO prepolymers of the invention with polyols takes place at temperatures between 20 and 200° C., preferably of 40 to 100° C., in accordance with reaction conditions that are known to the skilled person. To accelerate the reaction it is possible to use catalysts known to the skilled person, such as, for example, organometallic salts or metal-free bases. Suitable organometallic salts are dibutyltin dilaurate or zinc octoate. Suitable metal-free bases are triethylamine or diazabicyclooctane.

The moisture curing takes place normally at room temperature or at slightly elevated temperatures. In this context it is preferred to operate within a temperature range from 20 to 80° C., with 80° C. preferably not being exceeded. For the moisture curing it is likewise possible to use the aforementioned catalysts.

Alternatively the reaction of OH groups with CH-acidically blocked NCO groups may take place at 100-180° C. with elimination of monomeric alcohols. This reaction can also be accelerated by catalysts. This is generally done by using amines such as, for example, 1,5-diazabicyclo [4.3.0]non-5-ene (DBN) or 1,8-diazabicyclo[5.4.0]undec-7-ene (DBU).

According to a further alternative, the invention provides for the use of a composition obtained by the process and comprising low-monomer-content NCO prepolymers together with polyols, for producing paint, adhesives, plastics, composites and sealants.

The invention is elucidated below with a number of examples, without the invention being confined to these examples. However, the features in the examples may serve for general elucidation of the invention, and are therefore amenable to generalization.

### Examples

a) Preparation of low-monomer-content NCO prepolymers of the general formula (I) 1111 g (5 mol) of isophorone diisocyanate are admixed with 0.8 g of zinc octoate and then 160 g (1 mol of diethyl malonate are added dropwise over the course of 30 minutes. The mixture is held at 40° C. with stirring for 1 day. During this time the NCO number falls from 33.0% to 26.2% (theoretical 26.4%). After cooling, the mixture is subjected to a short-path distillation (150° C., 0.5 mbar, 160 ml/h). The resulting product has a free NCO number of 13.6%, an effective NCO number of 25.2%, a monomer content of 0.4 wt % and a viscosity of 8 Pas (at 80° C.).

b) Preparation of an OH-terminated urethane prepolymer and curing 48.7 g of the low-monomer-content NCO prepolymer from a) is dissolved in acetone with 41.35 g of Voranol CP 450 (polyether polyol, Dow, OH number 369) and the solution is admixed with 0.1 g of dibutyltin dilaurate. After 10 hours of stirring at 40° C. the acetone is stripped off. The NCO number of the resulting viscous oil has dropped to 0.

A portion of the product is dissolved in a little butyl acetate (30 wt %) and applied by knife coating to untreated steel panels (Bonder R36). Following evaporation of the solvent, curing is performed at 130° C. for 30 minutes. The results of this are as follows:

Film thickness: 40 μm, cross-cut 0 (no detachment), Erichsen cupping >10 mm, ball impact (dir/indir) >80/60 inch*lbs, pendulum hardness 76 sec, MEK test >100 double rubs (=chemicals-resistant) (Erichsen cupping to DIN 53156, ball impact to ASTM D 2794-93). A resistant and flexible paint film has been produced.

1. A composition comprising a prepolymer of formula I:
OCN—R—NH—(C=O)—B—(C=O)—NH—R—NCO (I)
which is obtained by, in order, (1) reacting:
(i) a monomeric diisocyanate compound of formula II:
OCN—R—NCO (II)
with
(ii) an organofunctional C—H-acidic compound having at least two acidic hydrogen atoms of formula III:
HBH (III),
where R in formula I and formula II in each case independently is a bifunctional organofunctional radical which comprises an aromatic, aliphatic and (cyclo)aliphatic or cycloaliphatic bifunctional radical,
the organofunctional C—H-acidic compound HBH of the formula III comprises a substituted linear aliphatic, (cyclo)aliphatic or branched aliphatic compound having 3 to 25 C atoms, which has an electron-withdrawing group or an electron-withdrawing substituent on a carbon atom, located alpha to the C—H-acidic carbon atom, and
(2) removing the unreacted monomeric compound of the formula II.

2. The composition according to claim 1, wherein
(ii) the organofunctional C—H-acidic compound HBH of the formula III comprises an electron-withdrawing group on a carbon atom located alpha to the C—H-acidic carbon atom.

3. The composition according to claim 1, wherein
(i) the diisocyanate compound of the formula II comprises isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), diisocyanatomethylcyclohexane (HXDI), toluidine diisocyanate (TDI), methylenediphenyl diisocyanate (MDI), tetramethylxylylene diisocyanate (TMXDI), or a mixture thereof.

4. The composition according to claim 1, wherein (ii) the organofunctional C—H-acidic compound HBH of the formula III comprises a linear aliphatic, (cyclo)aliphatic or branched aliphatic compound having 3 to 25 C atoms, selected from β-dicarbonyl compounds, diketones, keto esters, diesters, nitrile esters, dinitriles and cyclic diketones, and derivatives thereof.

5. The composition according to claim 1, wherein (ii) the organofunctional C—H-acidic compound HBH of the formula III is 1,3-cyclohexanedione, dimedone, a malonic diester, an acetoacetic ester, or a mixture thereof.

6. The composition according to claim 1, which comprises 0.1 wt % or more of said prepolymer.

7. A process for preparing a prepolymer of formula formula (I):
OCN—R—NH—(C=O)—B—(C=O)—NH—R—NCO (I)
comprising
reacting a molar excess of at least one aromatic, aliphatic, (cyclo)aliphatic and/or cycloaliphatic isocyanate of formula II:
OCN—R—NCO (II)
and
at least one organofunctional CH-acidic compound having at least two CH-acidic hydrogen atoms, of formula III:
HBH (III)
and
after the reaction, removing excess diisocyanate of the formula II.

8. The process according to claim 7, wherein the diisocyanate of the formula II comprises isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), diisocyanatomethylcyclohexane (HXDI), toluidine diisocyanate (TDI), methylenediphenyl diisocyanate (MDI) tetramethylxylylene diisocyanate (TMXDI), or a mixture thereof.

9. The process according to claim 7, wherein the C—H-acidic compound of the formula III comprises a linear aliphatic, (cyclo)aliphatic or branched aliphatic compound having 3 to 25 C atoms, selected from β-dicarbonyl compounds, diketones, keto esters, diesters, nitrile esters, dinitriles and cyclic diketones and derivatives thereof.

10. The process according to claim 7, wherein the C—H-acidic compound comprises 1,3-cyclohexanedione, dimedone, a malonic diester, an acetoacetic ester, or a mixture thereof.

11. The process according to claim 7, wherein the reaction of the diisocyanate and the CH-acidic compound is carried out at a molar ratio of 1.1:1 to 100:1.

12. The process according to claim 7, wherein the reaction is carried out at 20 to 200° C.

13. The process according to claim 7, wherein the reaction is carried out in the presence of a catalyst.

14. The process according to claim 7, wherein after the reaction excess diisocyanate of the formula II is removed by a gentle distillation.

15. The composition obtained by a process according to claim 7.

16. The composition according to claim 15, which has a monomer content of less than or equal to 2 wt %.

17-18. (canceled)

19. The composition according to claim 2, wherein the organofunctional C—H acidic compound HBH of the formula III has two electron-withdrawing groups on both alpha-located carbon atoms, the groups being selected from ester, sulfoxide, sulfone, nitro, phosphonate, nitrile, isonitrile and carbonyl groups.

20. The composition according to claim 5, wherein the organofunctional C—H-acidic compound HBH of the formula III is an ethyl or methyl ester of acetoacetic acid, acetylacetone or a mixture thereof.

21. The process according to claim 10, wherein the organofunctional C—H-acidic compound HBH of the formula III is an ethyl or methyl ester of acetoacetic acid, acetylacetone or a mixture thereof.

22. The process according to claim 11, wherein the molar ratio is 10:1 to 1:1.

23. The process according to claim 11, wherein the molar ratio is 5:1 to 2:1.

24. The process according to claim 12, wherein the reaction is carried out at 40 to 100° C.

25. The process according to claim 12, wherein the reaction is carried out until the theoretical NCO number corresponding to the molar reaction of two acidic hydrogen atoms of the C—H-acidic compound with the diisocyanate is reached.

26. The process according to claim 14, wherein the gentle distillation is a short-path distillation or a thin-film distillation carried out at a temperature of 100 to 180° C. and a pressure of 0.001 mbar to 100 mbar.

27. A process comprising mixing a polyol with the composition according to claim 1 and then reacting the prepolymer thereof with said polyol, the molar ratio of NCO groups to OH groups being from 1:10 to 10:1.
